(19) United States
(12) Patent Application Publication
(10) Pub. No.: US 2026/0344626 A1
(43) Pub. Date: Nov. 5, 2026

(54) FEEDER TYPE COVER BOARD

(71) Applicant: YILDIRIM PLASTIK MAKINE VE KALIP IMALAT INSAAT TURIZM SANAYI VE TICARET LIMITED SIRKETI, Istanbul (TR)

(72) Inventor: Muzaffer YILDIRIM, Istanbul (TR)

(73) Assignee: YILDIRIM PLASTIK MAKINE VE KALIP IMALAT INSAAT TURIZM SANAYI VE TICARET LIMITED SIRKETI, Istanbul (TR)

(21) Appl. No.: 19/488,604

(22) PCT Filed: May 27, 2024
(86) PCT No.: PCT/TR2024/050546

§ 371 Date: Nov. 27, 2025

(30) Foreign Application Priority Data
May 27, 2023 (TR) 2023/006108

(51) Int. Cl. A01K 53/00; A01K 47/06

(52) U.S. Cl. CPC A01K 53/00; A01K 47/06

(57) ABSTRACT

A feeder-type cover board is provided. The feeder-type cover board allows the bees to be provided with syrup and/or cake together or separately in separate areas by placing nutritional supplements on the top of the honeypot and in a way that they are placed under the cover board. The feeder-type cover board includes a solid nutrient section and a liquid nutrient section.

### CROSS REFERENCE TO THE RELATED APPLICATIONS

This application is the national phase entry of International Application No. PCT/TR 2024/050546, filed on May 27, 2024, which is based upon and claims priority to Turkish Patent Application No. 2023/006108, filed on May 27, 2023, the entire contents of which are incorporated herein by reference.

### TECHNICAL FIELD

The invention relates to feeder-type cover board that provides solid and liquid feeding without the need to open the inside of the beehive. With the design of the feeder, which is the subject of the invention, in the form of a cover board, the necessary beehive supplements can be provided without disturbing the bees and without causing a change in the internal temperature of the beehive.

### BACKGROUND

Honey bees obtain the nutrients they need in their natural lives from nectar and pollen sources. The nutrients honey bees need are carbohydrate, protein, vitamins, minerals, fat, and water. While bees obtain the carbohydrates they need from honey extract (nectar) and sweet secretory sources, they meet their remaining nutritional needs from pollen.

Pollen is rich in protein and meets the protein, vitamin, fat, and mineral needs of bees. As long as there is no pollen in the beehive, the reproduction of offspring and the development of the colony stop completely. On the other hand, although there is pollen in the honeycomb cells, if there is no honey and nectar flow to the beehive or if the colony does not have access to nutrients, serious problems will occur.

It is not enough to have only pollen and nutrients used instead of pollen in the colony for the start and continuation of the reproduction of the offspring. The colonies should also be provided with a source of sugar to induce the production of the offspring. When the queen bee begins to lay eggs with the sugar consumption of the colony, if there is pollen in the beehive, normal reproduction of the offspring is initiated and maintained. If there is no pollen in the colonies, the larvae will starve shortly after hatching because they will not receive enough nutrients.

For these reasons, additional nutritional supplements from outside are provided to the bee colony under certain conditions. Supplements used in the nutrition of bees can be summarized as honey, pollen, skimmed milk powder, skimmed soybean meal, water, and powdered sugar. However, beekeepers today mostly prefer to use cakes and syrup, which can be a liquid or solid mixture of one or more of these supplements as additional nutritional supplements.

Cakes are generally described as additional nutritional supplements with sweet and honey flavor and odor in solid form that do not contain unbound water.

Syrups, on the other hand, are mostly prepared in the form of sucrose-based solutions and provided to bees in liquid form.

In classical beehives, syrups are placed in containers called feeders made in various shapes and volumes and provided to bees. Said feeders are available in the form of glass jars, plastic special feeders, metal, or wood. In general, these feeders are positioned in the areas accessible to the colony in the beehive.

In classical beehives, plastic bags with cake, which have the consistency of bread dough. This plastic bag is torn from its area to contact the beehive and placed on the feeding hole or honeycombs and provided to the bees. The cake, which is in solid form, is placed on the honeycomb slats and provided to bees. However, the cake not having been made in the appropriate consistency can flow on the bees and cause problems.

The patent application numbered TR 2012/11817 mentions beehive feeders used for the feeding and care of bee colonies in beekeeping. It is understood that the beehive has a feeder positioned on the outer surface of the body.

The fact that such feeders have uncovered syrup or cake may lead to important handicaps. During feeding, bees can die by falling into the liquid deposit of the syrup or into the cake.

The patent numbered TR 2007/04519 mentions a feeder developed for the feeding of bees in beehives. The feeder comprises a body covering the frames in which the bees are located, an opening on the body and allowing the passage from the lower side of the body to the upper side of the body, and a lid covering the opening. Basically, the feeder, which is the subject of the application numbered 2007/04519, can also be defined as a feeder in the form of a cover board.

With the use of such structures, it is possible to provide the necessary beehive supplements without disturbing the bees and without causing a change in the internal temperature of the beehive.

With the use of feeder structures in the form of cover boards, a structure that both serves as a cover and can be operated as a feeder has been created. In this way, the inside of the beehive can be protected without the use of nettle cloth and sacks. Again, the fact that the feeder is located in the beehive and has a lid allows the prevention of robbing of the beehive. For example, the handicapped structure of the feeders outside the beehive described in the application numbered 2012/11817 can be eliminated.

The feeder-type cover boards are designed to provide air circulation in the beehives by offering highly practical solutions according to the different ways of working of the beekeepers. It allows solid and liquid feeding without disturbing the bees and without causing a change in the temperature in the beehive.

The existing feeder-type cover board mechanisms do not have structures suitable for providing bees with both the cake and the syrup together in separate sections of the feeder.

The feeder-type cover board shown on the shop.apimaye.com.tr/urunler/butun-yemlik-41/ and www.tarimtedarik.com/turbo-yemlik-seffaf web pages have a single area on their surface suitable for positioning syrup or cake. The beekeeper can either pour syrup or position the solid cake in this area. Since such existing embodiments do not include separate areas where both the cake and the syrup can be provided to the bee, they cause operational disadvantages.

Again, such structures allow the cake to be positioned in an opening and the bees to feed on the cake from this opening. The bees are taken to the syrup chamber created by the feeder and access the stacked cake directly. This embodiment both causes congestion during feeding and can cause damage to the bees.

The existing systems are not suitable for the bees to easily access both the cake and the syrup. For this reason, bees cannot be directed to syrup and cake effectively enough.

Within the existing systems, the syrup is poured directly into a chamber in the feeder. The bee is expected to feed in this liquid deposit. Considering that the syrup is a sticky liquid, bees can fall into the liquid in the syrup and die, especially in cases where the syrup is deep.

### SUMMARY

The invention aims to create feeder-type cover board that allows the bees to be provided with syrup and/or cake together or separately in separate areas by placing the nutritional supplements on the top of the honeypot and in a way they are placed under the cover board.

In this way, the feeder-type cover board can have both syrup and cake in different areas at the same time. The user can easily change and adjust the feeding position for the bees by changing the positions of the alternating lids while providing liquid and solid nutrients.

Bees can reach the cake or syrup through different channels or openings. The user can direct the bees to the food they want by closing or opening these channels or openings when they want.

The bees are not in direct contact with both the cake and the syrup. The cake is located inside the feeder and has a variety of passage holes at the lower section facing the bottom of the beehive. By using these holes, the bees can reach and feed on the cake through the beehive. However, since they are not in direct contact with the cake, bees are not damaged, and congestion does not occur.

Within the preferred embodiment of the invention, bees are not in direct contact with solid food because they can reach the solid food through the feeding holes.

Again, the entry and exit of the bees to the section that has the syrup chamber are provided by channels within the beehive. The exit sections of these channels are staged. In this way, the bees can feed on the staged section without direct contact with the syrup. This situation may allow the deaths based on the bees falling into the syrup to be reduced.

An inclined surface was formed on at least one part of the surface of the liquid nutrient section of the feeder-type cover board subject to the invention. In this way, the liquid nutrient added to the liquid nutrient section can be passed to the side sections where the bees are fed.

Thanks to this embodiment, the liquid nutrient can be directed to the sides of the beehive even if the beehive is positioned on different surfaces.

### BRIEF DESCRIPTION OF THE DRAWINGS

FIG. 1. A perspective view of the feeder-type cover board with the lids closed,

FIG. 2. A bottom view (from the direction of honeypot) of the feeder-type cover board,

FIG. 3. A perspective view of the feeder-type cover board with the solid nutrient section lid turned upside down and closed,

FIG. 4. A perspective view of the feeder-type cover board with the lids disassembled,

FIG. 5. A detailed view of the solid and liquid nutrients section,

FIG. 6. A perspective cross-sectional view of the solid and liquid nutrients section,

FIG. 7. A side cross-sectional view of the solid and liquid nutrients section,

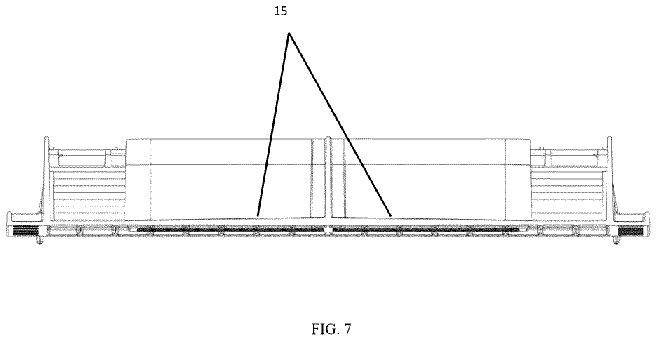

FIG. 8. A top view of the solid and liquid nutrients section,

### DESCRIPTION OF REFERENCES IN FIGURES

1. Solid nutrients section
2. Liquid nutrients section
3. Solid nutrient section lid
4. Liquid nutrient section lid
5. Solid section feeding holes
6. Liquid section passage grooves
7. Solid section separation wall
8. Passage groove lid
9. Passage opening
10. Staged area
11. Passage groove lid mounting detail
12. Solid nutrient section lid mounting groove
13. Solid nutrient section lid mounting detail
14. Channel
15. Inclined surface

### DETAILED DESCRIPTION OF THE EMBODIMENTS

The invention relates to feeder-type cover board that allows the bees to be provided with syrup and/or cake together in separate areas by placing nutritional supplements on the top of the honeypot and in a way that they are placed under the cover board.

Said feeder-type cover board includes the following:
a solid nutrient section (1) separated from the liquid nutrient section (2) with at least one solid section separation wall (7) having solid section feeding holes (5) for the bees to reach the cake located in the honey pot,
a liquid nutrient section (2) associated with at least one liquid section passage groove (6) for the entry of bees from the side of the honeypot.

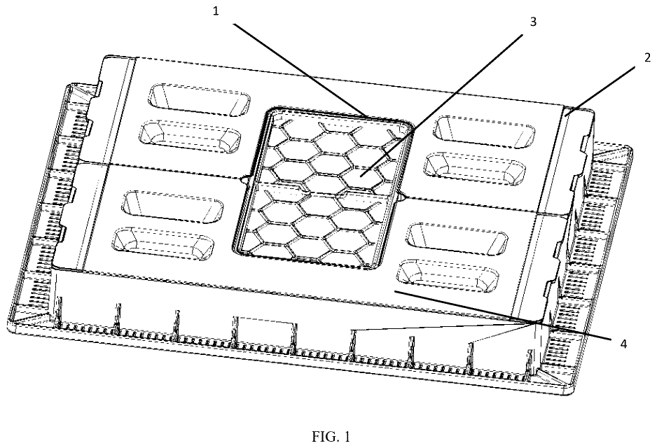

According to FIG. 1, the solid nutrient section (1) is located in the middle section of the feeder-type cover board. Within this embodiment, the perimeter of the solid nutrient section (1) is surrounded by the liquid nutrient section (2). The liquid nutrient section (2) and the solid nutrient section (1) may also be closed with the solid nutrient section lid (3) and the liquid nutrient section lid (4).

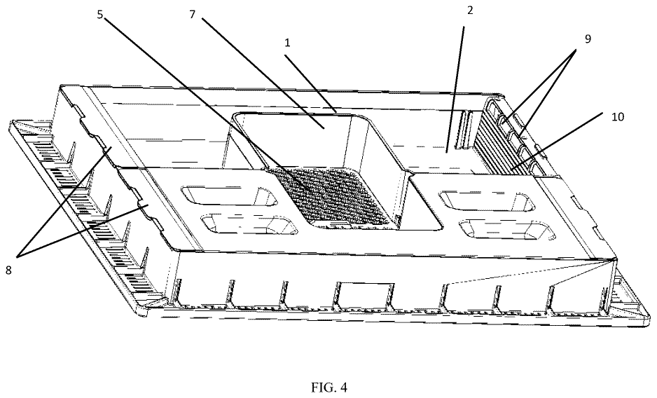

According to FIG. 1, the liquid nutrient section (2) may be closed with the liquid nutrient section lid (4). In FIG. 4, one of these lids (4) is shown disassembled.

In FIG. 1, the solid nutrient section lid (3) completely closes the solid nutrient section (1). In this position, the lid (3) covers only the solid nutrient section (1), and the bees can reach the cake by using the feeding holes (5) from the honeypot. This is the positioning of the lid (3) where the bees can reach the solid food.

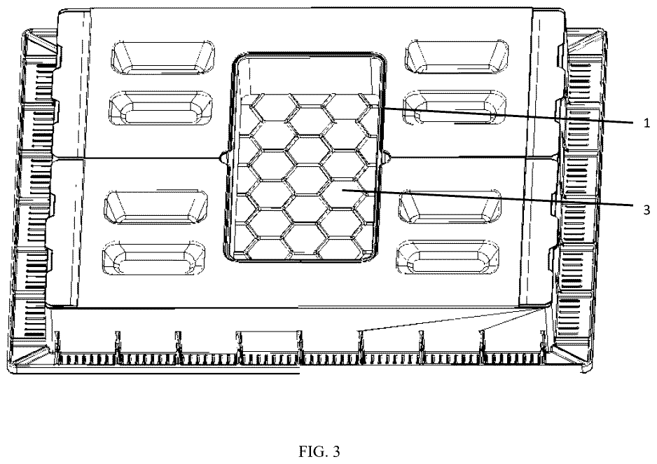

FIG. 3 describes the situation in which the solid nutrient section lid (3) is turned upside down and positioned in the solid nutrient section (1). In this case, the lid (3) will close the feeding holes (5) and the bees can be prevented from reaching the cake.

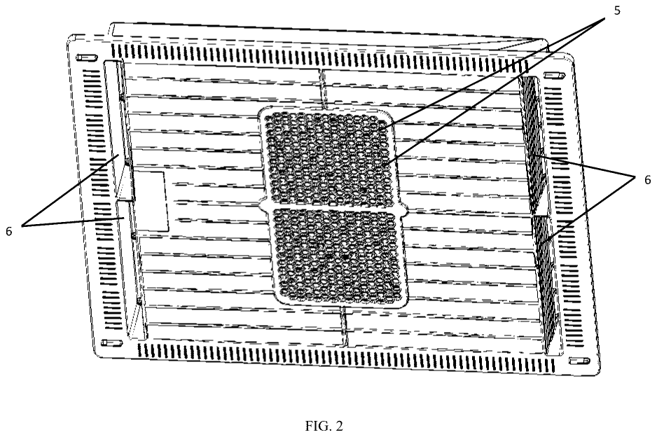

According to FIG. 2, the honeypot surface of the feeder-type cover board has openings for the liquid section passage groove (6). These grooves (6) start from the honeypot surface of the feeder-type cover board and extend to the liquid nutrient section (2).

According to FIG. 2, the honeypot surface of the feeder-type cover board has 4 liquid section passage grooves (6).

According to FIG. 4, the liquid section passage groove (6) is connected to the passage opening (9) on the other surface of the feeder-type cover board. Bees entering from the honeypot of the feeder-type cover board can enter the liquid nutrient section (2) through the passage opening (9).

According to FIG. 4, a staged area (10) was formed in the direction of the liquid nutrient section (2) of the passage openings (9). In this way, the bees can be fed over the staged area (10) without causing them to fall into the syrup on the ground.

Within the preferred embodiment of the invention, the staged area (10) is in the form of a ladder and extends to the surface of the liquid nutrient section (2).

Within this embodiment, the liquid section passage groove (6) was formed in the feeder-type cover board side sections and 10 passage openings (9) were formed on each side.

According to FIG. 4, the upper section of the passage openings (9) can also be closed with the passage groove lid (8). A passage groove lid mounting detail (11) is formed on the side wall so that the passage groove lid (8) can be connected to the side where the passage opening (9) is formed. Through this part, the passage groove lid (8) can be connected to the body.

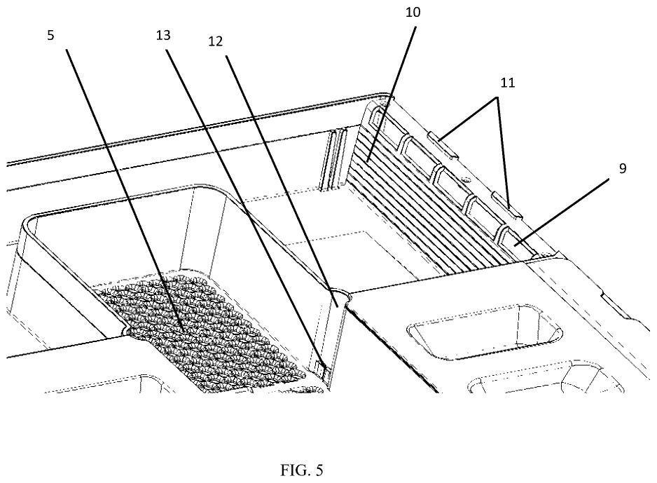

According to FIG. 5, the two lateral separation walls (7) of the solid nutrient section (1) are provided with the solid nutrient section lid mounting groove (12). The groove (12) aims to include the opposite detail of the solid nutrient section lid (3).

The groove (12) is also provided with the solid nutrient section lid mounting detail (13). This solid nutrient section lid mounting detail (13) aims to connect the solid nutrient section lid (3) in the groove (12).

Within the preferred embodiment of the invention, the feeder consists of three independent sections in total. According to FIG. 1, the feeder consists of 2 liquid nutrient sections (2) and a solid nutrient section.

This embodiment allows, for example, liquid feeding with two liquid nutrient sections (2) to each colony separately when it is desired that the beehive is operated with 2 colonies.

Within this embodiment, the liquid feeding units are on all sides and the bees can come from all sides according to the inclinations in the field conditions thanks to the base design of the feeder body.

An inclined surface (15) was formed on at least one part of the surface of the liquid nutrient section (2) of the feeder-type cover board subject to the invention. According to the preferred embodiment of the invention, the inclined surface (15) aims to direct the liquid nutrient to the sides of the liquid nutrient section (2).

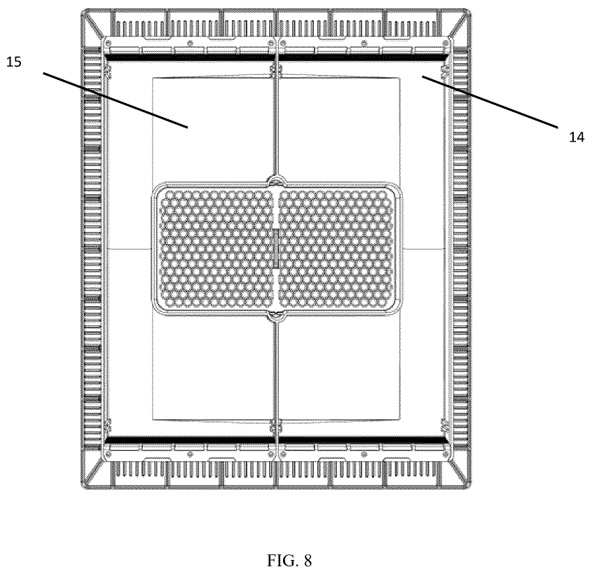

Within this embodiment, at least one part of the sides of the liquid nutrient section (2) is provided with a channel (14). According to FIG. 8, all of the sides of the liquid nutrient section (2) are provided with a channel (14).

The inclined surface (15) has a curve on an axis according to one of the preferred embodiments of the invention and directs the liquid nutrient to the sides of the liquid nutrient section (2).

In another embodiment, the inclined surface (15) has a slope on two axes and directs the liquid nutrient to the corners of the liquid nutrient section (2).

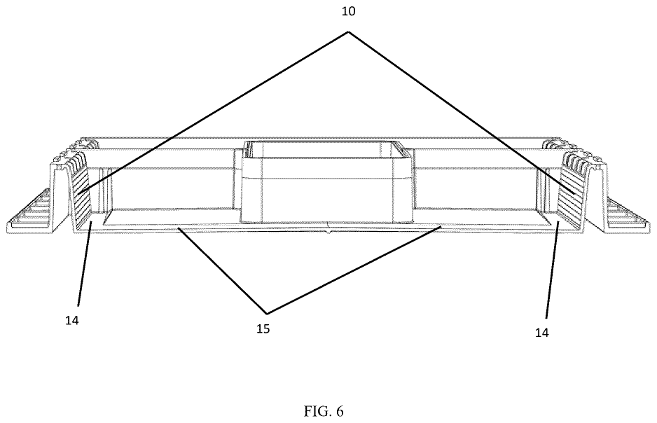

According to FIG. 6, the channel (14) is positioned next to the staged area (10). In this way, the liquid accumulated in the channel can be easily accessed by the bees in the staged area (10).

What is claimed is:

1. A feeder-type cover board, wherein the feeder-type cover board allows bees to be provided with syrup and/or cake together or separately in separate areas by placing the feeder-type cover board on a top of a honeypot, under a hive cover, and comprises the following:
a solid nutrient section separated from a liquid nutrient section with at least one solid section separation wall having solid section feeding holes for the bees to reach the cake located in the honeypot,
the liquid nutrient section associated with at least one liquid section passage groove for an entry of bees from a side of the honeypot.

2. The feeder-type cover board according to claim 1, wherein the solid nutrient section is positioned in the a central part of the feeder-type cover board and surrounded by the liquid nutrient section.

3. The feeder-type cover board according to claim 1, wherein the liquid nutrient section is configured to be closed with a liquid nutrient section lid, and the solid nutrient section is configured to be closed with a solid nutrient section lid.

4. The feeder-type cover board according to claim 1, wherein the liquid nutrient section is configured to be closed by 2 liquid nutrient section lids.

5. The feeder-type cover board according to claim 1, wherein a honeypot surface of the feeder-type cover board is provided with openings for the at least one liquid section passage groove, and the at least one liquid section passage grooves starts from the honeypot surface of the feeder-type cover board and extends to the liquid nutrient section.

6. The feeder-type cover board according to claim 5, wherein the honeypot surface of the feeder-type cover board is provided with 4 liquid section passage grooves.

7. The feeder-type cover board according to claim 5, wherein the at least one liquid section passage groove is connected to a passage opening on the other surface of the feeder-type cover board.

8. The feeder-type cover board according to claim 7, wherein the passage openings are formed in a staged area in a continuation of a surface of the liquid nutrient section.

9. The feeder-type cover board according to claim 8, wherein the staged area is in a form of a stair extending to the surface of the liquid nutrient section.

10. The feeder-type cover board according to claim 1, wherein the at least one liquid section passage groove is formed in side sections of the feeder-type cover board and connected to 10 passage openings on each side.

11. The feeder-type cover board according to claim 7, wherein an upper section of the passage opening is closed by a passage groove lid.

12. The feeder-type cover board according to claim 11, wherein a passage groove lid mounting detail is formed on a side wall so that the passage groove lid is allowed to connect to a side where the passage openings are formed.

13. The feeder-type cover board according to claim 1, wherein the solid nutrient section is provided with two lateral separation walls and a solid nutrient section lid mounting groove.

14. The feeder-type cover board according to claim 13, characterized wherein the solid nutrient section lid mounting groove is provided with a solid nutrient section lid mounting detail.

15. A feeder-type cover board, wherein the feeder-type cover board allows bees to be provided with syrup and/or cake together or separately in separate areas by placing the feeder-type cover board on a top of a honeypot, under a hive cover, wherein an inclined surface aiming to direct a liquid to side/corner sections of a liquid nutrient section is formed on at least one part of a surface of the liquid nutrient section.

16. The feeder-type cover board according to claim 15, wherein at least one of the side sections of the liquid nutrient section is provided with a channel.

17. The feeder-type cover board according to claim 16, wherein all of the side sections of the liquid nutrient section are provided with the channel.

18. The feeder-type cover board according to claim 15, wherein the inclined surface is curved on an axis and intended to direct a liquid nutrient to the side sections of the liquid nutrient section.

19. The feeder-type cover board according to claim 15, wherein the inclined surface is curved on two axes and intended to direct a liquid nutrient to the corner sections of the liquid nutrient section.

20. The feeder-type cover board according to claim 15, wherein the feeder-type cover board comprises a channel positioned next to a staged area.
